(19) United States
(12) Patent Application Publication
(10) Pub. No.: US 2017/0336513 A1
(43) Pub. Date: Nov. 23, 2017

(54) Personal Tracking System

(71) Applicant: Eddie Kirby, Boerne, TX (US)

(72) Inventor: Eddie Kirby, Boerne, TX (US)

(21) Appl. No.: 15/162,201

(22) Filed: May 23, 2016

(51) Int. Cl. G01S 19/14; G01S 19/42

(52) U.S. Cl. CPC G01S 19/14; G01S 19/42

(57) ABSTRACT

A personal tracking system includes an electronic device that may be carried by a user. The electronic device may be in wireless communication with an extrinsic communications network. A plurality of tracking units is provided. Each of the tracking units may be coupled to an associated one of a plurality of objects. Each of the tracking units is in wireless communication with the electronic device. The gps determines a location of each of the tracking units with respect to the electronic device. Thus, the electronic device may track the objects when the objects are worn on or carried by a person.

### BACKGROUND OF THE DISCLOSURE

### Field of the Disclosure

The disclosure relates to tracking devices and more particularly pertains to a new tracking device for tracking multiple individuals with respect to a user.

### SUMMARY OF THE DISCLOSURE

An embodiment of the disclosure meets the needs presented above by generally comprising an electronic device that may be carried by a user. The electronic device may be in wireless communication with an extrinsic communications network. A plurality of tracking units is provided. Each of the tracking units may be coupled to an associated one of a plurality of objects. Each of the tracking units is in wireless communication with the electronic device. The gps determines a location of each of the tracking units with respect to the electronic device. Thus, the electronic device may track the objects when the objects are worn on or carried by a person.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a personal tracking system according to an embodiment of the disclosure.

FIG. 2 is a schematic view of an embodiment of the disclosure.

### DESCRIPTION OF THE PREFERRED EMBODIMENT

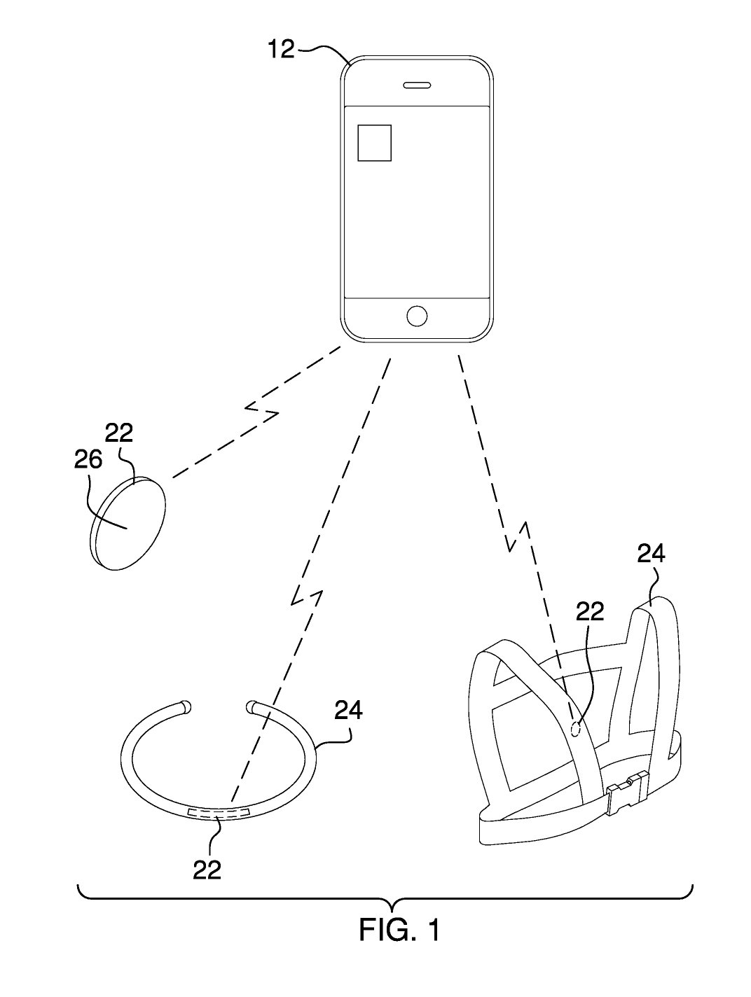

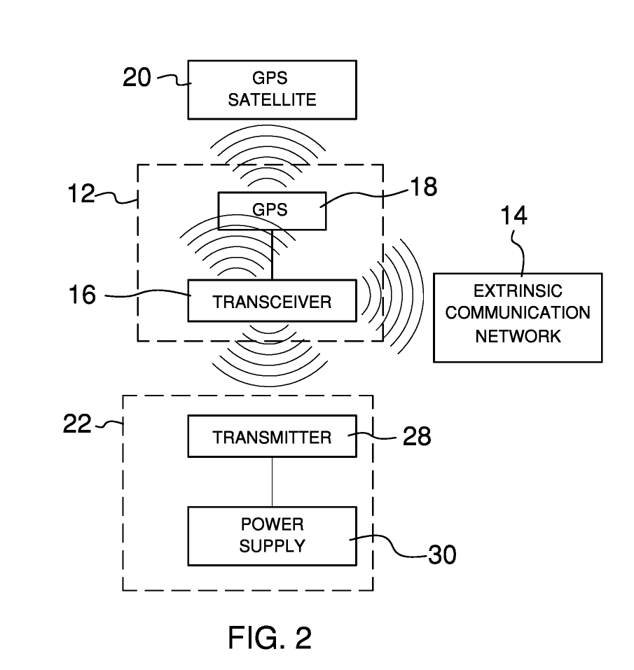

With reference now to the drawings, and in particular to FIGS. 1 through 2 thereof, a new tracking device embodying the principles and concepts of an embodiment of the disclosure and generally designated by the reference numeral 10 will be described.

As best illustrated in FIGS. 1 through 2, the personal tracking system 10 generally comprises an electronic device 12 that may be carried by a first user. The first user may be a parent or a care giver. The electronic device 12 may be in wireless communication with an extrinsic communications network 14. The electronic device 12 may comprise a smart phone or the like. The extrinsic communications network 14 may comprise a cellular phone network, the internet or other communications network.

The electronic device 12 may include an electronic memory and the electronic memory may store a tracking application or the like. The electronic device 12 has a transceiver 16 and a global positioning system (gps) 18. The gps 18 is electrically coupled to the transceiver 16. The gps 18 is in electrical communication with a gps satellite 20. The transceiver 16 may comprise a radio frequency transceiver or the like.

A plurality of tracking units 22 is provided. Each of the tracking units 22 may be coupled to an associated one of a plurality of objects 24. Each of the objects 24 may be carried by an associated one of a plurality of second users. The second users may be a child or other individual needing supervision. The objects 24 may comprise an article of clothing, a blanket, a toy or other object associated with a child. Each of the tracking units 22 may be sewn into the associated object 24. Additionally, each of the tracking units 22 may be resiliently coupled to the associated object 24 through any conventional means.

Each of the tracking units 22 is in wireless communication with the electronic device 12. The gps 18 determines a location of each of the tracking units 22 with respect to the electronic device 12. Thus, the electronic device 12 may track the objects 24 when the objects 24 are worn on or carried by each of the second users. The tracking application in the electronic device may receive the location of the objects 24 from the gps 18. Thus, the electronic device 12 may display the location of each of the second users for the first user to view.

Each of the tracking units 22 comprises a housing 26 that may be coupled to the associated object 24. A transmitter 28 is positioned within the housing 26 and the transmitter 28 is in electrical communication with the transceiver 16. Thus, the gps 18 may determine a location of the each of the second users with respect to the electronic device 12. The transmitter 28 may comprise a radio frequency transmitter or the like. Moreover, the transmitter 28 may employ a WPAN signal or the like. The WPAN signal may employ Bluetooth protocol or the like. Thus, the transmitter 28 may be synced with the transceiver 16.

A power supply 30 is positioned in the housing 26. The power supply 30 is electrically coupled to the transmitter 28. The power supply 30 comprises at least one battery 32. The battery 32 may comprise a button battery or the like.

In use, each of the tracking units 22 is coupled to the associated object 24 and each of the objects 24 is carried or worn by an associated second user. The electronic device 12 is carried by the first user. Each of the tracking unit 22 is in wireless communication with the electronic device 12. Thus, the gps 18 determines a location of each tracking unit 22 with respect to the electronic device 12. The first user may view the location of each tracking unit 22 on the electronic device 12. Thus, the first user monitors the location of each of the second users in a crowded public area or the like.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A personal tracking system comprising:
an electronic device being configured to be carried by a user, said electronic device being configured to be in wireless communication with an extrinsic communications network, said electronic device having a transceiver and a global positioning system, said global positioning system being electrically coupled to said transceiver, said global positioning system being in electrical communication with a global positioning system satellite;
a plurality of objects to be tracked, at least one said object to be tracked being an article of clothing; and
a plurality of tracking units, each of said tracking units being configured to be coupled to an associated one of a plurality of objects, each of said tracking units being in wireless communication with said electronic device to determine a location of each of said tracking units with respect to said electronic device wherein said electronic device is configured to track the objects when the objects are worn on or carried by a person, at least one said tracking unit being sewn into said article of clothing.

2. (canceled)

3. The system according to claim 1, wherein
each of said tracking units comprises:
a housing being configured to be coupled to the object; and
a transmitter being positioned within said housing, said transmitter being in electrical communication with said transceiver wherein said gps is configured to determine a location of the object with respect to said electronic device.

4. The system according to claim 1, further comprising a respective power supply being positioned in each said tracking unit, said power supply being electrically coupled to a transmitter, said power supply comprising at least one battery.

5. A personal tracking system comprising:
an electronic device being configured to be carried by a user, said electronic device being configured to be in wireless communication with an extrinsic communications network, said electronic device having a transceiver and a global positioning system, said global positioning system being electrically coupled to said transceiver, said global positioning system being in electrical communication with a global positioning system satellite;
a plurality of objects to be tracked, said objects to be tracked including at least one article of clothing; and
a plurality of tracking units, each of said tracking units being configured to be coupled to an associated one of a plurality of objects, each of said tracking units being in wireless communication with said electronic device to determine a location of each of said tracking units with respect to said electronic device wherein said electronic device is configured to track the objects when the objects are worn on or carried by a person, at least one said tracking unit being sewn into said article of clothing, each of said tracking units comprising:
a housing being configured to be coupled to the object,
a transmitter being positioned within said housing, said transmitter being in electrical communication with said transceiver wherein said gps is configured to determine a location of the object with respect to said electronic device, and
a power supply being positioned in said housing, said power supply being electrically coupled to said transmitter, said power supply comprising at least one battery.
